(19) United States
(12) Patent Application Publication
(10) Pub. No.: US 2005/0072284 A1
(43) Pub. Date: Apr. 7, 2005

(54) Method and apparatus for reducing damage to a circular saw blade on a delimbing machine

(76) Inventor: Claude Auger, Widewater (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/748,932

(22) Filed: Dec. 30, 2003

(30) Foreign Application Priority Data
Mar. 20, 2003 (CA) 2,422,984

(51) Int. Cl. B23D 45/00

(52) U.S. Cl. 83/478; 83/821

(57) ABSTRACT

A method and an apparatus for reducing damage caused to a circular saw blade on a delimbing machine. A step involves mounting at least one contact member to an inside surface of an access door of a saw head compartment. The at least one contact member is positioned immediately adjacent to and spaced radially inwardly from a lower circumferential peripheral edge of the circular saw blade when in a retracted position within the saw head compartment. Lateral movement of the lower circumferential peripheral edge of the circular saw blade is confined by the at least one contact member engaging a first face of the circular saw blade along the lower circumferential peripheral edge.

### FIELD OF THE INVENTION

The present invention relates to a method and an apparatus for reducing damage caused to a circular saw blade on a delimbing machine.

### BACKGROUND OF THE INVENTION

Delimbing machines with feed rollers are used to delimb felled trees. An example of such a delimbing machine is disclosed in U.S. Pat. No. 4,972,890 (Isley 1990). The delimbing machines have a boom which is capable of extending and retracting. Grapple arms are provided on a remote end of the boom. The delimbing machines are also provided with feed rollers and a transversely positioned circular saw. The circular saw blade moves from a stored position to an operative position. In the stored position, the circular saw blade partially retracted within a saw head compartment. In the operative position, the circular saw blade extends from the saw head compartment.

In operation, the machine operator extends and lowers the boom to engage a felled tree with the grapple arms. The machine operator then raises the boom to lift the felled tree off the ground and retracts the boom until the felled tree is engaged by the feed rollers. The grapple then slightly releases it grip on the felled tree and the feed rollers propel the felled tree through a tree guide tube. Delimbing cutters are provided which serve to delimb the tree as it is propelled through the tree guide tube. Once the tree has been delimbed, the feed rollers propel the delimbed tree back through the tree guide tube. The saw is actuated at selected intervals and moved from the stored to the operative position to cut the delimbed tree into desired lengths.

A problem is presently being experienced with the above described delimbing machines. Frequent maintenance is required to repair damage to the circular saw blades, which occurs when the feed rollers are propelling the tree through the tree guide tube. The circular saw blade is retracted out of the path of the delimbed tree when this movement occurs. However, frequently, stubs of branches remain after delimbing. When the delimbed tree is propelled past the circular saw blade, one of these stubs will occasionally be in an orientation that results in a violent lateral blow being delivered to the circular saw blade. The violent lateral blow drives the circular saw blade against the access door of the saw head compartment, damaging the teeth of the saw.

### SUMMARY OF THE INVENTION

What is required is a method and an apparatus for reducing damage caused to circular saw blades on delimbing machines.

According to one aspect of the present invention there is provided a method for reducing damage caused to a circular saw blade on a delimbing machine. A step involves mounting at least one contact member to an inside surface of an access door of a saw head compartment. The at least one contact member is positioned immediately adjacent to and spaced radially inwardly from a lower circumferential peripheral edge of the circular saw blade when in a retracted position within the saw head compartment. Lateral movement of the lower circumferential peripheral edge of the circular saw blade is confined by the at least one contact member engaging a first face of the circular saw blade along the lower circumferential peripheral edge.

According to another aspect of the present invention there is provided an apparatus for reducing damage caused to a circular saw blade on a delimbing machines. There is provided a saw head compartment of a delimbing machine. The saw head compartment having an access door with an inside surface. At least one contact member is mounted to the inside surface of the access door of the saw head compartment. The at least one contact member is positioned immediately adjacent to and spaced radially inwardly from a lower circumferential peripheral edge of the circular saw blade when in a retracted position within the saw head compartment. Lateral movement of the lower circumferential peripheral edge of the circular saw blade is confined by the at least one contact member engaging a first face of the circular saw blade along the lower circumferential peripheral edge.

Although beneficial results may be obtained through the use of the method and apparatus described above, even more beneficial results may be obtained by adding further contact members to the saw slide assembly. A support having at least one contact member is mounted to a saw slide assembly. The at least one contact member is positioned immediately adjacent to and spaced radially inwardly from an upper circumferential peripheral edge of the circular saw blade. Lateral movement of the upper circumferential peripheral edge of the circular saw blade is confined by the at least one contact member engaging a second face of the circular saw blade along the upper circumferential peripheral edge.

It is not material to the invention how many contact members are provided, there may be one or there may be more than one contact member. A preferred configuration will hereinafter be described in which three contact members are positioned on the inside surface of the access door and one contact member is positioned on the support which extends from the saw slide assembly.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view in partial section of an apparatus for reducing damage caused to a circular saw blade on a delimbing machine constructed in accordance with the teachings of the present invention.

FIG. 2 is a partially cut away front elevation view of a saw head compartment of a delimbing machine with an open access door, the saw head compartment having been modified to include the apparatus illustrated in FIG. 1.

FIG. 3 is a detailed side elevation view, in section, of a contact member from the apparatus illustrated in FIG. 1.

### DETAILED DESCRIPTION OF THE PREFERRED EMBODIMENT

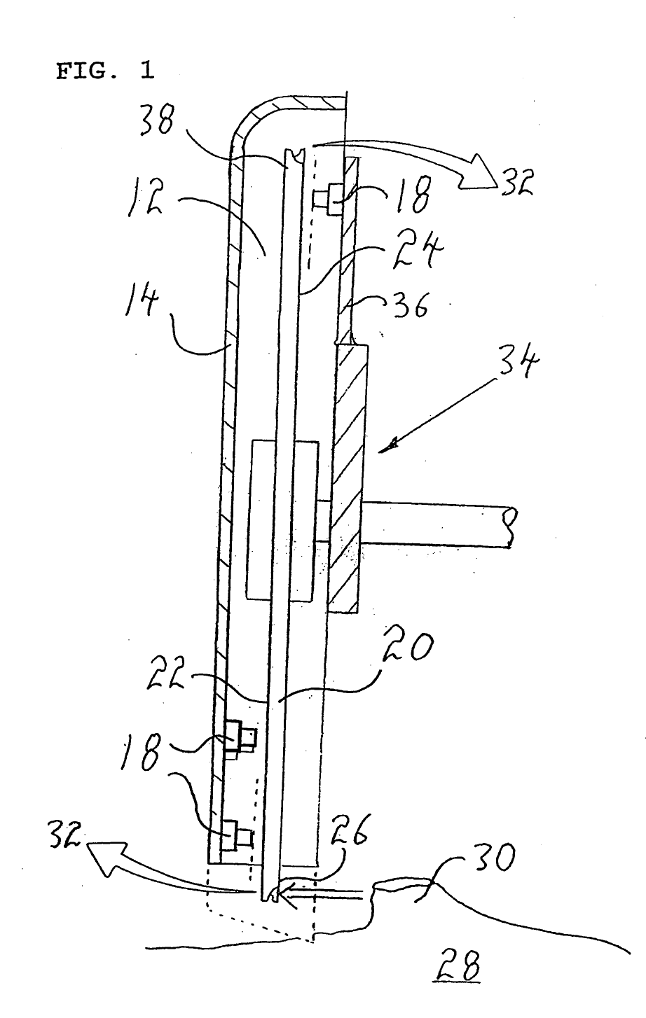

The preferred method and apparatus for reducing damage caused to circular saw blades on delimbing machines generally identified by reference numeral 10, will now be described with reference to FIGS. 1 through 3.

Structure and Relationship of Parts:

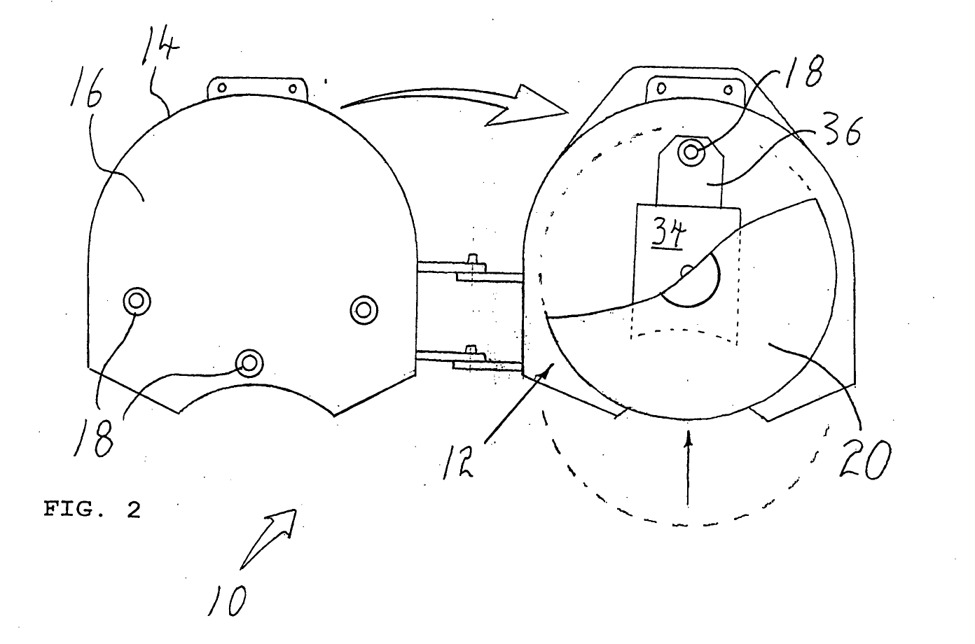

Referring to FIG. 2, apparatus 10 includes a saw head compartment 12 having an access door 14 with an inside surface 16. In accordance with the teachings of the present invention, a step involves mounting at least one contact member 18 to inside surface 16. In the illustrated embodiment, three contact members 18 are shown. Referring to FIG. 1, compartment 12 encloses a circular saw blade 20 having a first face 22 and a second face 24. According to the teachings of the present invention, contact members 18 are positioned immediately adjacent to and spaced radially inwardly from a lower circumferential peripheral edge 26 of blade 20 when in retracted position within compartment 12 as shown. In the event that a tree 28 with a stub 30 impacts upon blade 20, lateral movement 32 of blade 20 is then limited by contact members 18 upon engagement with first face 22 of blade 20. By limiting lateral movement 32, blade 20 is saved from harmful contact with any part of access door 14.

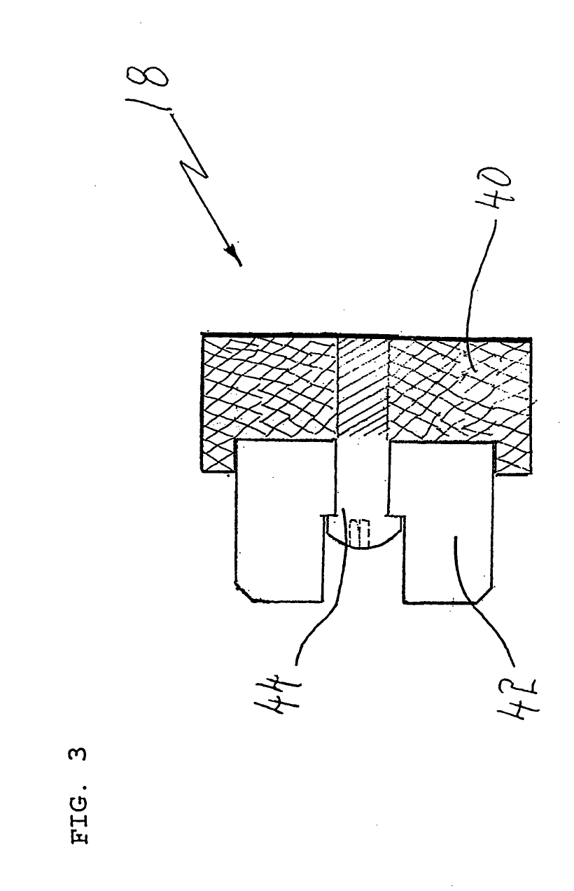

Referring to FIG. 1, compartment 12 also has a saw slide assembly 34. Assembly 34 is positioned adjacent to blade 20 opposite second face 24. In accordance with the teachings of the present invention, a further step involves mounting a support 36 on assembly 34 within compartment 12. In the illustrated embodiment, another contact member 18 is mounted to support 36 and positioned immediately adjacent to and spaced radially inwardly from an upper circumferential peripheral edge 38 of blade 20 when in retracted position within compartment 12 as shown. In the event that a tree 28 with a stub 30 impacts upon blade 20, lateral movement 32 of blade 20 is again limited, this time by contact member 18 upon engagement with second face 24 of blade 20. It will be appreciated that other configurations and numbers of contact members 18 may be used at either lower circumferential peripheral edge 26 or upper circumferential peripheral edge 38. Referring to FIG. 3, contact member 18 has a mounting portion 40 is welded in position and a wear portion 42 which is secured to mounting portion 40 by a mounting screw 44. As wear portion 42 becomes worn, it can readily be replaced by detaching mounting screw 44 to replace wear portion 42. It will be appreciated that other means of attachment may be used.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

1. A method for reducing damage caused to a circular saw blade on a delimbing machine, the method comprising the step of:
mounting at least one contact member to an inside surface of an access door of a saw head compartment, the at least one contact member being positioned immediately adjacent to and spaced laterally and radially inwardly from a lower circumferential peripheral edge of the circular saw blade when in a retracted position within the saw head compartment, such that lateral movement of the lower circumferential peripheral edge of the circular saw blade is confined by the at least one contact member engaging a first face of the circular saw blade along the lower circumferential peripheral edge.

2. (CANCELED)

3. The method as defined in claim 1, there being more than one contact member.

4. An apparatus for reducing damage caused to a circular saw blade on a delimbing machine, comprising:
a saw head compartment of a delimbing machine, the saw head compartment having an access door with an inside surface;
at least one contact member mounted to the inside surface of the access door of the saw head compartment, the at least one contact member being positioned immediately adjacent to and spaced laterally and radially inwardly from a lower circumferential periphera edge of the circular saw blade when in a retracted position within the saw head compartment, such that lateral movement of the lower circumferential periphera edge of the circular saw blade is confined by the at least one contact member engaging a first face of the circular saw blade along the lower circumferential periphera edge.

5. (CANCELED).

6. The apparatus as defined in claim 4, wherein there is more than one contact member.

7. An apparatus for reducing damage caused to a circular saw blade on a delimbing machine, the apparatus comprising:
a saw head compartment, for a delimbing machine, having an access door with an inside surface;
a saw blade rotatably supported within the saw head compartment;
at least one contact member mounted to the inside surface of the access door of the saw head compartment, the at least one contact member being positioned adjacent but spaced laterally and radially inwardly from a circumferential peripheral edge of the circular saw blade, and when the saw blade, during operation thereof, is biased laterally, a circumferential side face of saw blade contacts and is confined by the at least one contact member to resist further lateral movement of the saw blade and minimize damage thereto
